(19) United States
(12) Patent Application Publication
(10) Pub. No.: US 2003/0117553 A1
(43) Pub. Date: Jun. 26, 2003

(54) Liquid crystal display device

(75) Inventor: Yoshitaka Yamada, Saitama-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/319,590

(22) Filed: Dec. 16, 2002

(30) Foreign Application Priority Data
Dec. 18, 2001 (JP) 2001-384896

(51) Int. Cl. G02F 1/1335

(52) U.S. Cl. 349/113

(57) ABSTRACT

A liquid crystal display device is capable of preventing the picture quality from becoming poor in both transparent and reflective modes of operation. The liquid crystal display device 1 of the present invention includes first and second substrates 11 and 21 provided opposite to each other, a plurality of pixel electrodes 19 disposed on a surface of the first substrate 11 opposite to the second substrate 21, a common electrode 24 provided on a surface of the second substrate 21 opposite to the first substrate 11, a liquid crystal layer held between the first and second substrates 11 and 21, and the pixel electrodes 19 each having transparent and reflective portions 19a and 19b which are made of electrically conductive but optically reflective and transparent films 17 and 18, respectively, and are disposed in parallel. The reflective and transparent films 17 and 18 are electrically connected to each other, and a surface of the reflective film 17 on the second substrate side is coated with the same materials as the transparent film 18.

### FIELD OF THE INVENTION

This invention generally relates to a liquid crystal display device and, in particular, a liquid crystal display device which is capable of operating in an optically transparent, reflective or combination mode.

### BACKGROUND OF THE INVENTION

Display devices of compact terminals, such as mobile phones, pagers, etc. have been good enough in use where they have a simple character display function of numerals, characters, etc. Recent remarkable developments in information technologies demand to make practical use of a more sophisticated display device which is light in weight, thin in thickness, low in electric power consumption, and high in picture resolution and which is capable of displaying color pictures.

One of the best possible display devices to satisfy those demands is an active matrix color liquid crystal display device with a combination type of reflective and transparent modes of operation. Such a color liquid crystal display device is being put to practical use. Japanese Patent Publication No. Tokkaihei 11-316382, for instance, discloses a liquid crystal display device with pixel electrodes made of optically transparent and reflective but electrically conductive films to operate reflective and transparent modes, respectively. The reflective mode is operative in a highly illuminated environment, e.g., in the daytime outdoor. The transparent mode, however, is driven by a rear light source so that it is operative in the dark, e.g., in the night. Thus, a picture is visible on the liquid crystal display device under any illumination circumstances.

In the case that measures for the transparent mode are taken to prevent a picture on such a liquid crystal display device from becoming poor in quality, e.g., image sticking, mouth fading mura (blemishes) of its display section or flickering, it is turned out that those measures are not effective in the reflective mode, and vise versa. Thus, the measures for such a combination type liquid crystal display device do not always work out sufficiently.

Accordingly, the object of the present invention is to provide a combination type liquid crystal display device with measures which are capable of preventing poor picture quality in both transparent and reflective modes.

### SUMMARY OF THE INVENTION

The present invention is directed to a liquid crystal display device which includes first and second substrate provided opposite to each other, a plurality of pixel electrodes disposed on a surface of the first substrate opposing to the second substrate, a common electrode disposed on a surface of the second substrate opposing to the first substrate, and a liquid crystal layer held between the pixel and common electrodes. Each pixel electrode has transparent and reflective portions made of electrically conductive but optically transparent and reflective films, respectively, which are provided in parallel with each other on the first substrate and which are electrically connected to each other. Further, a surface of the reflective film on the second substrate side is coated with an electrically conductive but optically transparent film made of the same material as the transparent film electrically connected to the reflective film.

The transparent film of the transparent portion and that coating the reflective film may contain electrically conductive but optically transparent oxide, such as indium-tin-oxide (ITO) alloy.

The reflective film may contain metal materials. Such metal materials are, for instance, silver generally used for a reflective layer, high melting point metal of molybdenum, tungsten and tantalum, and alloy of those materials.

The liquid crystal display device may further include a plurality of switching elements electrically connected to the pixel electrodes on the first substrate.

The liquid crystal display device may yet further include a light source provided on a backside of the first substrate with respect to the liquid crystal layer.

### BRIEF DESCRIPTION OF THE DRAWINGS

FIG. 1 is a schematic sectional view of an embodiment of a liquid crystal display device in accordance with the present invention;

FIG. 2 is a schematic arrangement of pixel electrodes which are applicable to the liquid crystal display device shown in FIG. 1; and

FIG. 3 is a schematic sectional view of a prior art liquid crystal display device.

### DETAILED EXPLANATION OF THE INVENTION

An embodiment of the present invention is explained with reference to the attached drawings. In the drawings, same reference numerals show substantially the same or similar elements and redundant explanation thereof are omitted for the sake of simplicity.

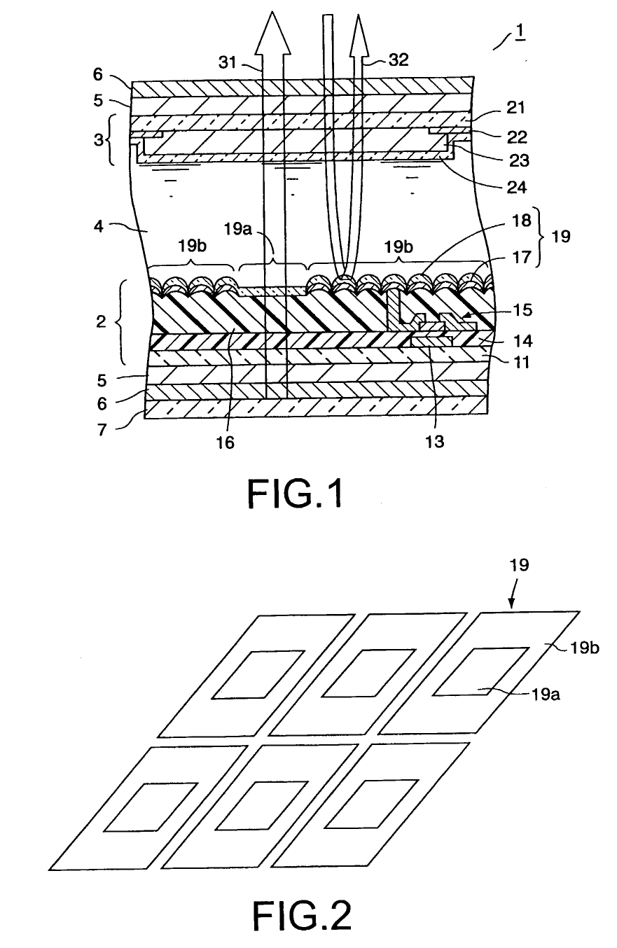

FIG. 1 is a schematic sectional view of a liquid crystal display device in accordance with an embodiment of the present invention. The liquid crystal display device shown in FIG. 1 is operative in one of transparent, reflective and combination modes to display a color picture. It includes an active matrix and a counter substrates 2 and 3 provided opposite to each other and a liquid crystal layer 4 held between the substrates 2 and 3. Peripheral portions of the substrates 2 and 3 are provided with an adhesive layer (not shown) except an inlet (not shown either) for injecting the liquid crystal. The inlet is sealed with sealant after the completion of such injection. A λ/4 (quarter wavelength) plate 5 and a polarizer 6 are put on both surfaces of the liquid crystal display device 1 and a rear light 7 is disposed on its back surface.

Arrows 31 and 32 show light from a light source being incident on the liquid crystal layer 4 and traveling toward an observer. Namely, the arrows 31 and 32 indicate light traveling directions in the transparent and reflective modes of the liquid crystal display device 1, respectively.

The active matrix substrate 2 of the liquid crystal display device 1 shown in FIG. 1 has a transparent substrate 11, such as a glass substrate. The substrate 11 is provided with address lines 13 or the like and an interlayer insulation layer 14 to coat the lines 13 or the like. A switching element (thin film transistor called “TFT”) 15 and a transparent resin layer 16 to cover the switching element 15 are formed on the interlayer insulation layer 14. On the resin layer 16 electrically conductive reflective film 17 electrically connected to TFT 15, an electrically conductive transparent film 18 and an alignment layer, not shown, are laminated in order.

The counter substrate 3 includes a transparent substrate 21, such as a glass substrate, on which a black matrix 22 and a color filter layer 23 are formed. Further, a common electrode 24 which is an electrically conductive transparent film and an alignment layer, not shown, are laminated in order on the black matrix 22 and the color filter layer 23.

FIG. 2 is a schematic perspective view of the pixel electrodes which are applicable to the liquid crystal display device 1 shown in FIG. 1. FIG. 2 depicts six pixel electrodes 19 disposed on the substrate 11. Each pixel electrode 19 has a transparent portion 19a and a reflective portion 19b surrounding the transparent portion 19a. In this embodiment, the transparent portion 19a is configured with a single layer section of the transparent film 18 under which the reflective film 17 is not provided while the reflective portion 19b is configured with a laminated section of the transparent film 18 and the reflective film 17.

The transparent portion 19a and the reflective portion 19b may be of various configurations. As shown in FIG. 2, for example, the reflective portion 19b encircles the transparent portion 19a. Since opaque lines, such as signal lines, address lines or the like are disposed at peripheral portions of the pixels, the electrode structure schematically shown in FIG. 2 has an advantage from a view point of optical efficiency.

Next, components of the liquid crystal display device will be explained below with reference to FIGS. 1 and 2.

The address line 13 or the like formed on the active matrix substrate 2 contains metal materials, such as aluminum, molybdenum, copper or the like. The switching element 15 is a TFT which includes a semiconductor layer, such as amorphous silicon or polysilicon, and a metal layer containing aluminum, molybdenum, chromium, copper or tantalum. The semiconductor layer is connected to the address line 13 through interlayer insulator 14 while the metal layer is connected to the pixel electrode of the transparent film 18 through the reflective film 17. With this structure, the pixel electrode 19 in the active matrix substrate 2 is selectively supplied with driving voltages.

The interlayer insulation layer 14 is made of a transparent insulation material, such as a transparent resin. The interlayer insulation layer 14 and the transparent resin filme 18 may be formed by using a light-sensitive resin. The interlayer insulation layer 14 and the transparent film 18 have contact holes in which electrically conductive materials are filled. The address line 13 or the like is connected to the switching element 15 through the electrically conductive material of the contact holes. Similarly, the switching element 15 is connected to the pixel electrode 19 through the electrically conductive material in the contact holes.

The transparent film 18 which is a part of the pixel electrode 19 is made of an electrically conductive but optically transparent materials. Such transparent materials used commonly for the transparent film 18 and the common electrode 24 are, for instance, electrically conductive but optically transparent oxide, such as alloy of indium, tin and oxide (ITO). The transparent film 18 and the common electrode 24 maybe formed by applying a known sputtering method.

The reflective film 17 which is another part of the pixel electrode 19 may also contain metal materials, such as silver and aluminum, which are used as an ordinary reflective layer. Further, high melting point metals, such as molybdenum, tungsten, or tantalum, or their alloy may be provided between aluminum and ITO to avoid direct contact from a view of chemical stability. The common reflective film 17 may be formed by applying a sputtering method, for example.

The surface of the reflective film 17 on the side of liquid crystal layer 4 may be formed with a plurality of convex structures in cross sectional view as shown in FIG. 1. Such convex structures brings about a wider viewing angle of the liquid crystal display device 1 in the reflective mode. The convex structures are made by the following method. First, a plurality of resin columns are made before forming of the reflective film 17. Second, the columns are heated to melt and are made into bases, the surfaces of which have a plurality of convex structures. Finally, the reflective film 17 is formed on the bases so that the surface of the film 17 on the side of the liquid crystal layer 4 has a plurality of convex structures.

The black matrix 22 is made of a mixture of a black pigment, such as carbon minute particles, a black dye and light-sensitive resin.

The color filter layer 23 consists of red, green and blue color layers corresponding to the pixel electrodes 19. Those color layers are made of a mixture of a light sensitive resin and color pigments or dyes, for example.

The alignment layers not shown in FIG. 1 are made of thin transparent resin films, such as polyimide, the alignment process of which is carried out by rubbing their surfaces.

As set forth below, the liquid crystal display device 1 is capable of preventing its picture quality from becoming poor in both transparent and reflective modes of operation.

Since the liquid crystal layer 4 is made of organic materials, the liquid crystal molecules are electrolyzed and its life becomes short if a direct electric current is continuously applied to the liquid crystal layer 4. To avoid this phenomenon an alternative electric current is ordinarily applied between the pixel and common electrodes 19 and 24.

Where positive and negative side voltages of an alternative current voltage applied to the pixel electrode 19 to drive the liquid crystal layer 4 are V₁ and V₂, respectively, and a voltage applied to the common electrode 24 is V_{com}, the positive and negative voltages V(+) and V(−) actually applied to the liquid crystal layer 4 are expressed by the following equations, respectively:

V(+)=V₁−V_{com}, and (1)

V(−)=V_{com}−V₂ (2)

Generally, the voltage V_{com} is adjusted to make absolute values |V(+)| and |V(−)| equal, namely:

|V(+)|=|V(−)| (3)

If such absolute values are not equal, |V(+) | |V(−)|, a direct current component is derived from the voltage applied to the liquid crystal layer 4 and causes displaying pictures poor due to image sticking, mouth fading mura (blemishes), flickering, etc. The common voltage V_{com} is hereinafter called the optimum common voltage V_{com} in the case where the equation (3) is fulfilled.

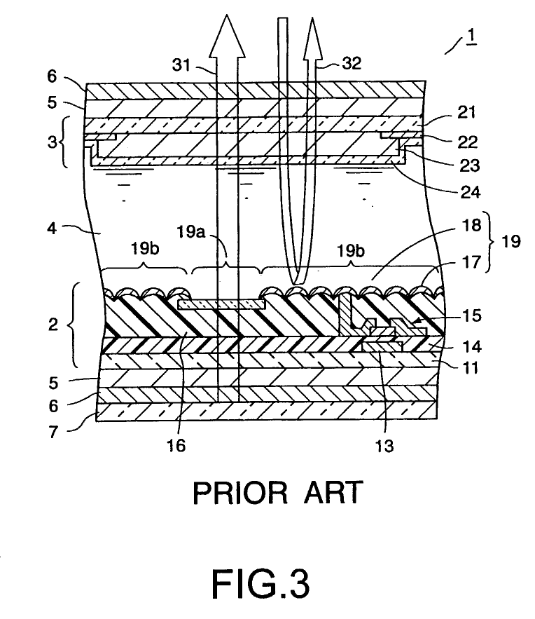

FIG. 3 shows a schematic sectional view of a prior art liquid crystal display device. Such a prior art liquid crystal display device is the same as the liquid crystal display device 1 shown in FIG. 1 except for a reflective portion 19b in which a reflective film 17 is not coated with a transparent film 18 in the case of the former. Thus, the liquid crystal display device 1 shown in FIG. 3 has the reflective and transparent films 17 and 18 corresponding to the reflective and transparent portions shown in FIG. 2, respectively.

In order to avoid becoming poor pictures due to the direct current component, the common voltage V_{com} must be deviate within ±0.1 V from the optimum common voltage V_{com}. Namely, where the optimum voltage V_{com} for the reflective portion 19b and that V_{com} for the transparent portion 19a are V_{com1} and V_{com2}, respectively, both voltages V_{com1} and V_{com2} must be within ±0.1 V in deviation from the optimum voltage V_{com}.

The difference between the voltages V_{com1} and V_{com2}, is, however, larger than 0.2 V in the liquid crystal display device 1 shown in FIG. 3. Thus, in the case where the voltage V_{com1} is set to be within 0.1 V from the optimum common voltage V_{com}, the voltage V_{com2} is larger than ±0.1 V from the optimum common voltage V_{com}. As a result, it causes a poor picture quality due to image sticking, mouth fading mura (blemishes), flickering, etc. on the reflective portion 19b. Where the voltage V_{com2}, however, is set to be within ±0.1 V from the optimum common voltage V_{com}, the voltage V_{com1} is not within ±0.1 V but larger than it from the optimum common voltage V_{com}. As a result, it causes a poor picture quality due to image sticking, mouth fading mura (blemishes), flickering, etc. on the transparent portion 19a. The prior art liquid crystal display device 1 shown in FIG. 3 is not capable of avoiding such a poor picture quality in either transparent or reflective mode of operation.

The inventors of this application have analyzed reasons for such a big difference between the voltages V_{com1} and V_{com2} in the prior art liquid crystal display device 1 shown in FIG. 3. As a result, they have discovered a cause that a voltage applied to the liquid crystal layer 4 shift relatively in ground level because the materials for the transparent and reflective portions are different, i.e., their work functions are different from each other.

Based upon such discovery the inventors have thought that the work functions for the transparent and reflective portions 19a and 19b will be equal to each other if the reflective film 17 on the side of the liquid crystal layer 4 is coated with the transparent film 18 of the transparent portion 19a. In short, the transparent and reflective portions 19a and 19b are configured to the structure shown in FIG. 1 so that the voltages V_{com1} and V_{com2} may be equal to each other and so that both voltages V_{com1} and V_{com2} may be within ±0.1 V from the optimum common voltage V_{com}. Thus, the liquid crystal display device 1 shown in FIG. 1 is easily capable of preventing from becoming poor in picture quality in both transparent and reflective modes of operation.

In the embodiment, it is desirable to electrically connect the transparent film 18 of the transparent portion 19a to the reflective portion 19b. In that case, however, it is not necessary to specifically provide electric lines for connecting them.

There are various modifications to the embodiment of the present invention. The transparent film 18 of the transparent portion 19a and the reflective portion 19b, for example, may be formed by independently different processes or by the same one at once. In the former, the transparent film 18 of the transparent portion 19a can be different in thickness from the reflective portion 19b. In the latter, the production process becomes simple.

The thickness of the transparent film 18 generally ranges from 30 nm to 150 nm. Where the transparent film 18 is extremely thin, the reflective film 17 of the reflective portion 19b has an influence on the work function of the reflective portion 19b. Where the transparent film is, however, more than 30 nm, the transparent and reflective portions are set to be substantially the same in work function. In this case, the electric resistance (sheet resistance) of the transparent film 18 can be made sufficiently low in value. It is preferable to make the transparent film much thicker from view points of the work function and the electric resistance but it takes much longer time to form such thicker transparent film. Thus, the thickness of the transparent film 18 is usually made equal to or less than 150 nm.

In the embodiment set forth above, the reflective film 17 is covered by the transparent film 18 but another additional transparent film may be provided between them if the reflective film 17 is electrically connected to the transparent film 18. In the event that such an additional transparent film is made of transparent insulation materials, a contact hole may be provided in the additional transparent film filled with an electrically conductive materials to electrically connect the reflective film 17 to the transparent film.

Further, although the black matrix 22 and the color filter layer 23 are disposed on the counter substrate 3 in the embodiment, they may be provided on the active matrix substrate 2. The display modes of the liquid crystal display device 1 is not limited to a specific mode so that it may be not only birefringence modes, such as TN or VAN mode, but also the other modes.

A method of making The liquid crystal display device 1 shown in FIG. 1 is explained hereinafter. The transparent and reflective portions 19a and 19b are formed in the schematic configuration as shown in FIG. 2.

Forming films and patterning processes are repeated as an ordinary process of making thin film transistors to form lines, such as address lines 13, on the glass substrate 11, the interlayer insulation layer 14 and the thin film transistor 15. The convex structures on the surface of the transparent resin layer 16 are made by applying the method to the resin layer 16 as set forth above.

Next, silver is sputtered on the transparent resin layer 16 through a predetermined mask to form a silver film. A predetermined photoresist pattern is then formed on the silver film. Exposed portions of the silver film are etched by using the photoresist pattern as a mask. Thus, the reflective film 17 made of silver is formed.

Subsequently, an ITO is sputtered on the surface of the reflective film 17 formed on the glass substrate 11 through a predetermined mask pattern. A photoresist pattern is then made on the ITO film and exposed portions of the ITO film are etched by using that photoresist pattern as a mask. As a result, the transparent film 18 made of a 100 nm ITO film is prepared. The transparent film 18 of the transparent and reflective portions 19a and 19b are made at the same time.

The polyimide alignment layer is formed on the transparent film 18 on the glass substrate 18 and is rubbed with clothes for alignment. Thus, the active matrix substrate is prepared.

While the active matrix substrate 2 is being made, the black matrix 22 and the color filter layer 23 are successively made on the glass substrate 21 by an ordinary well known method. An ITO film is formed on the color filter layer 23 of the glass substrate 21 as the common electrode by means of a sputtering method. The alignment layer, not shown, is formed on the entire surface of the common electrode 24 and is processed by the same method as for that of the transparent film 18. Thus, the counter substrate 3 is prepared.

The alignment layers of the active matrix and counter substrates 2 and 3 are arranged to face opposite to each other with a gap. The substrates 2 and 3 are fixed by the sealant except for an inlet to inject liquid crystal materials to make a liquid crystal cell. A cell gap is kept constant by holding spacers made of resin beads between the active matrix and counter substrates 2 and 3.

The liquid crystal layer 4 is made by using an ordinary method of injecting liquid crystal materials from the inlet to the cell gap. The inlet is sealed by sealant made of an ultraviolet-ray setting resin. The λ/4 (quarter wavelength) plate 5 and the polarizer 6 are put on both surfaces of the liquid crystal display cell and the rear light 7 is disposed on its back surface. Thus, the liquid crystal display device 1 shown in FIG. 1 is completed.

As for the display device 1 shown in FIG. 1, the inventors have measured the optimum voltages V_{com1} and V_{com2} for the transparent and reflective portions 19a and 19b on the conditions of V₁=9V and V₂=1V (positive and negative side voltages of an alternative current voltage applied to the pixel electrode 19, respectively). As a result, they have obtained V_{com1}=V_{com2}=4.6V, i.e., the optimum voltages V_{com1} and V_{com2} for the transparent and reflective portions 19a and 19b are consistent with each other.

The inventors have further investigated whether the picture quality becomes poor on the conditions of V₁=9V, V₂=1V and V_{com}=4.6V in the liquid crystal display device 1 shown in FIG. 1. As a result, they have recognized that the picture quality has not become poor at all due to image sticking, mouth fading mura (blemishes) or flickering in either the reflective or transparent mode.

Comparison

The liquid crystal display device 1 shown in FIG. 3 has been made for comparison purposes by using substantially the same method as set forth above. The transparent and reflective portions are made to have configurations as shown in FIG. 2 for the comparison purposes. In the comparison device, aluminum is used as materials of the reflective film 17 and the reflective and transparent films 17 and 18 are not contacted but electrically connected to each other through molybdenum.

The inventors have also measured the optimum voltages V_{com1} and V_{com2} for the transparent and reflective portions 19a and 19b on the conditions of V₁=9V and V₂=1V (positive and negative side voltages of an alternative current voltage applied to the pixel electrode 19, respectively). As a result, they have obtained that V_{com1} is about 5.0V but V_{com2} is about 4.5V, i.e., there has been difference by about 0.5V between the optimum voltages V_{com1} and V_{com2} for the transparent and reflective portions 19a and 19b.

The inventors have further checked whether the picture quality becomes poor in the prior art liquid crystal display device 1 shown in FIG. 3 on the conditions of V₁=9V, V₂=1V and V_{com}=5.0V. As a result, they have recognized that the picture quality is not significantly poor in the reflective mode but it becomes poor in the transparent mode due to image sticking, mouth fading mura (blemishes), flickering, etc.

Similarly, the inventors have additionally checked whether the picture quality becomes poor in the liquid crystal display device shown 1 in FIG. 3 on the conditions of V₁=9V, V₂=1V and V_{com}=4.5V. As a result, the picture quality is not significantly poor in the transparent mode but it becomes poor in the reflective mode due to image sticking, mouth fading mura (blemishes), flickering, etc.

In summary, the liquid crystal display device shown in FIG. 3 cannot prevent the picture quality from becoming poor in either the reflective or transparent mode.

As explained above, according to the present invention, the surface of the reflective film of the pixel electrodes on the liquid crystal layer side is coated with the same electrically conductive but optically transparent material film as is used for the transparent portion of the pixel electrodes. Thus, the work function of the transparent portion of the pixel electrodes is substantially equal to that of the reflective portion of the pixel electrodes so that it can prevent the picture quality from becoming poor in both transparent and reflective modes of operation. This invention provides a combination type liquid crystal display device to keep good in picture quality in its transparent and reflective modes of operation.

What I claim is:

1. A liquid crystal display device comprising:
first and second substrates provided opposite to each other,
a plurality of pixel electrodes disposed on a surface of said first substrate opposite to said second substrate,
a common electrode provided on a surface of said second substrate opposite to said first substrate,
a liquid crystal layer held between said first and second substrates, and
said pixel electrodes each including transparent and reflective portions which are made of electrically conductive but optically transparent and reflective films, respectively, and are disposed in parallel with each other,
wherein said transparent and reflective films are electrically connected to each other, and
a surface of said reflective film on said second substrate side is coated with the same materials as said transparent film.

2. The liquid crystal display device according to claim 1, wherein said transparent film contains oxide.

3. The liquid crystal display device according to claim 1, wherein said reflective film contains silver.

4. The liquid crystal display device according to claim 1, wherein said transparent film contains indium tin oxide, and
said reflective film contains silver.

5. The liquid crystal display device according to claim 1, 2, 3 or 4, further comprising;
a light source provided on a rear side with respect to said liquid crystal layer.
